(19) United States
(12) Patent Application Publication
(10) Pub. No.: US 2025/0219837 A1
(43) Pub. Date: Jul. 3, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei lu, Beijing (CN)

(21) Appl. No.: 18/852,228

(22) PCT Filed: Apr. 6, 2022
(86) PCT No.: PCT/CN2022/085422

§ 371 Date: Sep. 27, 2024

(51) Int. Cl. H04L 9/32

(52) U.S. Cl. CPC H04L 9/3226

(57) ABSTRACT

An information processing method is performed by a first network element, and includes: receiving an operator credential configured by a second network element for a Personal Internet of Things Network Element (PINE); encrypting the operator credential to obtain an encrypted credential; and sending the encrypted credential to the second network element, wherein the encrypted credential is used for a PIN Element with Gateway Capability (PEGC) to perform decryption to obtain the operator credential.

### CROSS REFERENCE TO RELATED APPLICATION

The present application is a U.S. National Stage of International Application No. PCT/CN2022/085422, filed on Apr. 6, 2024, the content of which is incorporated herein by reference in its entirety.

### TECHNICAL FIELD

The present disclosure relates to, but is not limited to, the wireless communication technical field, and in particular to an information processing method and apparatus, a communication device and a storage medium.

### BACKGROUND

There are types of Internet of Things (IoT) devices to meet different application requirements.

Based on the greatly increasing number of IoT devices, users mainly create (e.g., plan, change topology) networks using all these IoT devices at home, in the office, in factories, and/or around their bodies. A Personal IoT Network (PIN) may include various devices that users frequently use.

### SUMMARY

Embodiments of the present disclosure provide an information processing method and apparatus, a communication device, and a storage medium.

A first aspect of an embodiment of the present disclosure provides an information processing method. The method is performed by a first network element, and the method includes:
receiving an operator credentials configured by a second network element for a Personal Internet of Things Network Element (PINE);
encrypting the operator credential to obtain an encrypted credential; and
sending the encrypted credential to the second network element, wherein the encrypted credential is used for a PIN Element with Gateway Capability (PEGC) to perform decryption to obtain the operator credential.

A second aspect of an embodiment of the present disclosure provides an information processing method. The method is performed by a second network element, and the method includes:
after receiving a result of passing a default credential authentication for a PINE, configuring an operator credential for the PINE;
sending the operator credential and an identifier of a PEGC to a first network element, wherein the operator credential is used by the first network element to perform encryption and generate an encrypted credential based on a security algorithm supported by a PEGC indicated by the identifier of the PEGC;
receiving the encrypted credential; and
sending the encrypted credential to a third network element, wherein the encrypted credential is used to be decrypted by the PEGC and then provided to the PINE.

A third aspect of an embodiment of the present disclosure provides an information processing method. The method is performed by a third network element, and the method includes:
receiving an encrypted credential sent by a second network element; and
sending the encrypted credential to a PEGC, wherein the encrypted credential is an operator credential of a PINE encrypted according to a security algorithm supported by the PEGC.

A fourth aspect of an embodiment of the present disclosure provides an information processing method. The method is performed by a PEGC, and the method includes:
receiving an encrypted credential sent by a third network element;
decrypting the encrypted credentials to obtain an operator credential of a PINE; and
sending the operator credential to the PINE.

A fifth aspect of an embodiment of the present disclosure provides an information processing apparatus. The apparatus includes:
a first receiving module configured to receive an operator credential configured by a second network element for a Personal Internet of Things Network Element (PINE);
an encryption module configured to encrypt the operator credential to obtain an encrypted credential;
a first sending module configured to send the encrypted credential to the second network element, wherein the encrypted credential is used for a PIN Element with Gateway Capability (PEGC) to perform decryption to obtain the operator credential.

A sixth aspect of an embodiment of the present disclosure provides an information processing apparatus. The apparatus includes:
an allocation module configured to, after receiving a result of passing a default credential authentication for a PINE, configure an operator credential for the PINE;
a second sending module configured to send the operator credential and an identifier of a PEGC to the first network element, wherein the operator credential is used by the first network element to perform encryption and generate an encrypted credential based on a security algorithm supported by a PEGC indicated by the identifier of the PEGC; and
a second receiving module configured to receive the encrypted credential;
wherein the second sending module is configured to send the encrypted credential to a third network element, wherein the encrypted credential is used to be decrypted by the PEGC and then provided to the PINE.

A seventh aspect of an embodiment of the present disclosure provides an information processing apparatus. The apparatus includes:
a third receiving module further configured to receive an encrypted credential sent by a second network element;
a third sending module further configured to send the encrypted credential to a PEGC, wherein the encrypted credential is an operator credential of a PINE encrypted according to a security algorithm supported by the PEGC.

An eighth aspect of an embodiment of the present disclosure provides an information processing apparatus. The apparatus includes:
a fourth receiving module configured to receive an encrypted credential sent by a third network element;
a decryption module configured to decrypt the encrypted credential to obtain an operator credential of a PINE; and
a fourth sending module configured to send the operator credential to the PINE.

A ninth aspect of an embodiment of the present disclosure provides a communication device, including a processor, a transceiver, a memory, and an executable program stored in the memory and runnable by the processor. When the processor runs the executable program, the information processing method provided in any of the first to fourth aspects is implemented.

A tenth aspect of an embodiment of the present disclosure provides a computer storage medium. The computer storage medium stores an executable program. When the executable program is executed by a processor, the information processing method provided in any of the first to fourth aspects can be implemented.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the embodiments of the present disclosure.

FIG. 1 is a schematic structural diagram of a wireless communication system according to an example embodiment;

FIG. 2 is a flowchart of an information processing method according to an example embodiment;

FIG. 3 is a flowchart of an information processing method according to an example embodiment;

FIG. 4 is a flowchart of an information processing method according to an example embodiment;

FIG. 5 is a flowchart of an information processing method according to an example embodiment;

FIG. 6 is a flowchart of an information processing method according to an example embodiment;

FIG. 7 is a flowchart of an information processing method according to an example embodiment;

FIG. 8 is a flowchart of an information processing method according to an example embodiment;

FIG. 9 is a flowchart of an information processing method according to an example embodiment;

FIG. 10 is a flowchart of an information processing method according to an example embodiment;

FIG. 11 is a flowchart of an information processing method according to an example embodiment;

FIG. 12 is a schematic diagram showing the structure of an information processing apparatus according to an example embodiment;

FIG. 13 is a schematic diagram showing the structure of an information processing apparatus according to an example embodiment;

FIG. 14 is a schematic diagram showing the structure of an information processing apparatus according to an example embodiment;

FIG. 15 is a schematic diagram showing the structure of an information processing apparatus according to an example embodiment;

FIG. 16 is a schematic diagram showing the structure of a UE according to an example embodiment;

FIG. 17 is a schematic diagram of the structure of a communication device according to an example embodiment.

### DETAILED DESCRIPTION

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of embodiments of the present disclosure.

The terms used in embodiments of the present disclosure are for the purpose of describing example embodiments only and are not intended to limit the embodiments of the present disclosure. As used in the present disclosure, the singular forms “a”, “an”, “said” and “the” are intended to include a plural form as well, unless the context clearly dictates otherwise. It will also be understood that the term “and/or” as used herein refers to and includes any and all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” as used herein may be interpreted as “when” or “upon” or “in response to determining . . . ”.

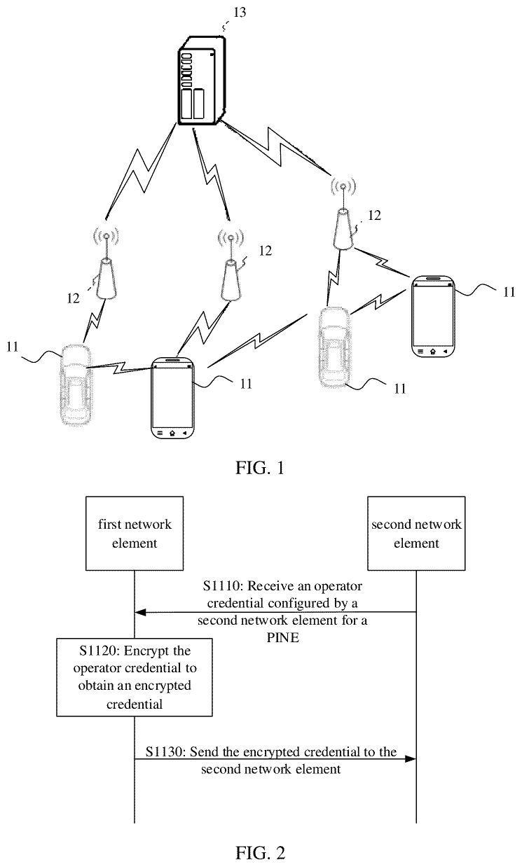

FIG. 1 shows a schematic structural diagram of a wireless communication system provided by an embodiment of the present disclosure. As shown in FIG. 1, the wireless communication system is a communication system based on cellular mobile communication technologies. The wireless communication system may include multiple UEs 11 and multiple access devices 12.

A UE 11 may be a device that provides voice and/or data connectivity to a user. The UE 11 may communicate with one or more core networks via a Radio Access Network (RAN). The UE 11 may be an Internet of Things UE, such as a sensor device, a mobile phone (or referred to as a “cellular” phone), and a computer with an Internet of Things UE, for example, it can be a fixed, portable, pocket-sized, handheld, computer-built-in or vehicle-mounted device. For example, the user equipment 110 may be a station (STA), a subscriber unit, a subscriber station, a mobile station, a mobile, a remote station, an access point, a remote UE (remote terminal), an access UE (access terminal), a user terminal, a user agent, a user device, or user equipment (UE). Alternatively, the UE 11 may be equipment of an unmanned aerial vehicle. Alternatively, the user equipment 110 may be a vehicle-mounted device, for example, it may be an on-board computer with a wireless communication function, or a wireless communication device connected to an external on-board computer. Alternatively, the UE 11 may be a roadside device, for example, it may be a streetlight, a signal light or other roadside device with a wireless communication function.

An access device 12 may be a network side device in a wireless communication system. The wireless communication system may be the 4th generation mobile communication (4G) system, also known as the Long Term Evolution (LTE) system; or, the wireless communication system may be a 5G system, also called new radio (NR) system or 5G NR system. Alternatively, the wireless communication system may be a next-generation system of the 5G system. The access network in the 5G system may be called New Generation-Radio Access Network (NG-RAN). Alternatively, it may be a MTC system.

The access device 12 may be an evolved access device (eNB) used in the 4G system. Alternatively, the access device 12 may be a access device (gNB) using a centralized distributed architecture in the 5G system. When the access device 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer; a distributed unit is provided with a physical (PHY) layer protocol stack. The embodiments of the present disclosure do not limit the specific implementation of the access device 12.

A wireless connection may be established between an access device 120 and a UE 11 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

There are three types of Personal IoT Network Element (PINE): a device with a gateway function (PIN Element with Gateway Capability, PEGC), a device with a management function (PIN Element with Management Capability, PEMC), and an ordinary PINE without gateway and management functions.

The PEGC and the PEMC may also be UEs that are able to directly access the 5G network. The PEMC may also access the 5G network through the PEGC.

The IoT devices that make up PINE include, but are not limited to: wearable devices, smart home devices, and/or smart office devices.

Wearable devices include but are not limited to: headphones, smart watches and/or health monitoring sensors.

Smart home devices include, but are not limited to: smart lights, cameras, thermostats, access control devices, voice assistant devices, speakers, refrigerators, washing machines, lawn mowers, and/or robots.

Smart office devices may be used in offices or factories of small businesses. Typical smart office devices include but are not limited to: printers, meters and/or sensors.

Some IoT devices have very specific requirements in terms of size (e.g. headphones), and some IoT devices have very specific requirements in terms of weight (e.g. glasses).

Some IoT devices have very specific requirements across multiple domains (i.e. size, weight, and power consumption).

A PINE is not able to directly access the 5G network, while the 5G network needs to identify the PINE for enhanced management (or in other words, 5GS needs to further authenticate the PINE to achieve enhanced management of PINE). To fulfill the demand, the 5G network needs to provision an operator credential for the PINE. With the operator credential, the fifth generation mobile communication system (5^{th} Generation System, 5GS) can authenticate and identify the PINE connected to the PEGC. However, in related art, for PIN scenarios, there is still a lack of a technology to enable securely configuring of an operator credential.

Before provisioning the operator credential issued by 5GS to the PINE, a default credential of the PINE need to be authenticated. However, there is a lack of a mechanism to authenticate a default credential provided by a third-party Authentication, Authorization, and Accounting (AAA) server through 5G Core (5GC), which delays the 5GC's communication control on the PIN E, resulting in communication latency.

As shown in FIG. 2, an embodiment of the present disclosure provides an information processing method. The method is performed by a first network element and includes:

In S1110, an operator credential configured by a second network element for a PINE is received.

In S1120, the operator credential is encrypted to obtain an encrypted credential.

In S1130, the encrypted credential is sent to the second network element, where the encrypted credential is transmitted to a PEGC and is decrypted to obtain the operator credential issued for the PIN.

The first network element may be any core network element. As an example, the first network element includes but is not limited to an Authentication Server Function (AUSF).

The second network element may also be a core network element. As an example, the second network element includes but is not limited to Unified Data Management (UDM).

The operator credential may be a credential configured by an operator of a 3GPP network. If the PINE is configured with the operator credential, the first network element receives the operator credential sent by the second network element. The first network element and the second network element can communicate with each other, and the first network element and the second network element are mutually trusted network elements. The second network element performs operator credential configuration, and the first network element provides various security processing, and the security processing here includes but is not limited to: encryption processing, generation of a verification code for integrity check protection and/or generation of reception acknowledgement value, etc. In this way, after the first network element receives the operator credential, the first network element encrypts the operator credential to obtain the operator credential after encryption, and the operator credential after encryption is referred to as the encrypted credential.

After completing the encryption of the operator credential, the first network element returns the encrypted credential to the second network element. In this way, the second network element can transmit the encrypted credential to the PEGC through forwarding of one or more network elements in the network, so that the PEGC can decrypt the encrypted credential, and provide the operator credential to the PINE. This method facilitates the PINE to quickly implement network access authentication and communication authentication subsequently based on the operator credential, reduces network access and communication latency, and improve network access and communication efficiency for the PINE.

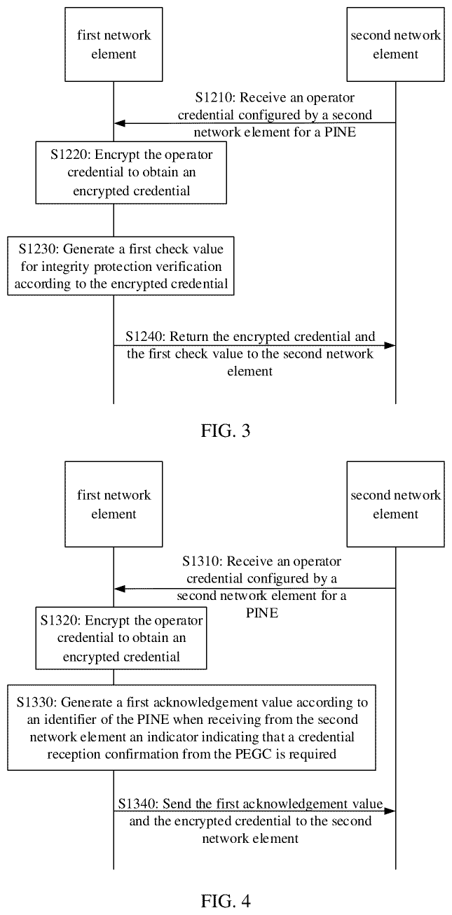

As shown in FIG. 3, an embodiment of the present disclosure provides an information processing method. The method is performed by a first network element and includes:

In S1210, an operator credential configured by a second network element for a PINE is received.

In S1220, the operator credential is encrypted to obtain an encrypted credential.

In S1230, a first check value for integrity protection verification is generated according to the encrypted credential.

In S1240, the encrypted credential and the first check value are returned to the second network element. The encrypted credential is used for a PIN Element with Gateway Capability (PEGC) to perform decryption to obtain the operator credential. The first check value and the encrypted credential are provided to the PEGC together.

In an embodiment, the first check value and the encrypted credential are sent to the second network element together, or the first check value and the encrypted credential are sent to the second network element separately.

In an embodiment of the present disclosure, the first check value is a check value used to perform integrity check protection on the encrypted credential.

The first check value is a calculated value obtained according to a selected integrity check protection algorithm, with at least the encrypted credential as a dependent variable.

After the first check value and the encrypted credential are transmitted together to the PEGC of the PINE, the PEGC performs an integrity check on the encrypted credential based on the first check value, thereby reducing situations where the encrypted credential is tampered with during transmission and improving the security of the encrypted credential during transmission.

In some embodiments, the S1230 may include:
according to the encrypted credential, a length of the encrypted credential, a parameter update count value, a length of the parameter update count value, and a first key used for key derivation of the first network element, generating the first check value.

In an embodiment, there are multiple ways to generate the first check value. For example, the first check value may be generated using the encrypted credential itself and its own parameter(s) such as the length of the encrypted credential as dependent variables. For another example, a hash value obtained by processing the encrypted credential using hash distribution or the like may be used as the first check value. Of course, the above just gives some examples, and the specific implementation is not limited to the examples.

In another embodiment, when generating the first check value, the encrypted credential itself and other parameter(s) in addition to the encrypted credential itself such as the length of the encrypted credential are introduced to generate the first check value.

As an example, in addition to the encrypted credential and the length of the encrypted credential, a parameter update count value, the length of the parameter update count value and a first key used for key derivation of the first network element are introduced as parameter values of the first check value.

The parameter update count value may be a count value of a UE Parameters Update (UPU) counter maintained in the first network element. The count value of the UPU counter is originally used to count UE parameters update requests. In an embodiment of the present disclosure, the count value of the UPU counter is reused as a parameter for calculating the first check value. In other embodiments, the parameter update count value may also be replaced by a count value of other counter(s). For example, a dedicated counter may be maintained during the operator credential configuration procedure for each PINE, and the parameter update count value may be replaced according to the count value of the dedicated counter.

For example, the length of the parameter update count value is: the number of bits occupied by the parameter update count value. For example, the parameter update count value is 8, which is written as “1000” in binary, and the length of the current parameter update count value is 4.

The first key is a key used by the first network element to derive other key(s), that is, the first key may be a root key for the first network element to derive other key(s). As an example, if the first network element is AUSF, the first key may be Kausf. The Kausf is generated according to the key hierarchy of the fifth generation mobile communication system (5GS).

The first check value is generated according to the encrypted credential, the length of the encrypted credential, the parameter update count value, the length of the parameter update count value, and the first key used for key derivation of the first network element, without increasing the number of parameters maintained by the first network element. In addition, multiple parameters are used to generate the first check value, which can increase the difficulty of cracking the first check value.

As shown in FIG. 4, an embodiment of the present disclosure provides an information processing method. The method is performed by a first network element and includes:

In S1310, an operator credential configured by a second network element for a PINE is received.

In S1320, the operator credential is encrypted to obtain an encrypted credential.

In S1330, a first acknowledgement value is generated according to an identifier of the PINE when receiving from the second network element an indicator indicating that a credential reception confirmation from the PEGC is required.

In S1340, the first acknowledgement value and the encrypted credential are sent to the second network element, where the first acknowledgement value is used to be compared with a second acknowledgement value returned by the PEGC after the PEGC confirms reception of the operator credential.

The information processing method provided in the embodiments of the present disclosure may be implemented alone or in combination with any of the foregoing embodiments. For example, the information processing method provided in this embodiment may also be implemented in combination with the information processing method shown in FIG. 3, that is, the first network element generates the first check value and the first acknowledgement value while generating the encrypted credential.

The first acknowledgement value may be used to verify whether the PEGC has received the encrypted credential.

In the embodiment of the present disclosure, verification of whether the PEGC has received the operator credential is not done through a simple acknowledgement message, but requires verification by generating the first acknowledgement value through a specific algorithm, thereby reducing the risk that the acknowledgement is forged and further improving the security of the operator credential configuration.

The indicator may include one or more bits. As an example, when the indicator includes one bit, two values “0” and “1” of the bit value represent that the credential reception confirmation from the PEGC is required and that the credential reception confirmation from the PEGC is not required, respectively.

In some embodiments, the second network element may indicate that a credential reception confirmation from the PEGC is required, or may indicate that a credential reception confirmation from the PEGC is not required. If the second network element indicates the credential reception confirmation from the PEGC is not required, the first network element does not need to generate the first acknowledgement value.

In another embodiment, if the second network element does not specifically indicate that the credential reception confirmation from the PEGC is required, that is, the first network element does not receive the above indicator, then the first network element determines by default that the credential reception confirmation from the PEGC is not required, and does not generate the first acknowledgement value.

In an embodiment, the first acknowledgement value may be generated according to an identifier of the PINE, for example, the first acknowledgement value is generated according to the identifier of the PINE alone. The identifier of the PINE includes but is not limited to: International Mobile Equipment Identity (IMEI) or MAC address. The identifier of the PINE includes but is not limited to: a device identifier of the PINE.

In another embodiment, the first acknowledgement value may also be generated according to a device identifier of the PEGC. For example, the device identifier of the PEGC (or the identifier of the PEGC or the PEGC identifier for short) may include but is not limited to: a Subscription Concealed Identifier (SUCI) and/or a Subscription Permanent Identifier (SUPI) of the PEGC. As an example, the first acknowledgement value is generated according to the identifier of the PEGC and/or the PIN identifier alone.

In some further embodiments, generating the first acknowledgement value according to the identifier of the PINE includes:
generating the first acknowledgement value according to the identifier of the PINE, the length of the device identifier, the parameter update count value, the length of the parameter update count value, and the first key used for key derivation of the first network element.

In the embodiment of the present disclosure, when generating the first acknowledgement value, the identifier of the PINE, the length of the device identifier, the parameter update count value, and the length of the parameter update count value may be used as calculation parameters to generate the first acknowledgement value. The calculation of the first acknowledgement value can share the parameter update count value, the length of the parameter update count value, and the first key, and thus the first network element does not need to maintain more calculation parameters, thereby reducing the cost of the first network element for generating the first acknowledgement value.

In some embodiments, the method includes:
receiving security capability information of the PEGC; and
selecting a security algorithm for protecting the operator credential according
to the security capability information.

In order to facilitate PEGC to decode the encrypted credential, the first network element needs to select a security algorithm supported by PEGC when perform security algorithm selection.

The security algorithms here include but are not limited to at least one of the following:
a confidentiality protection algorithm, commonly known as an encryption algorithm, which is used for data encryption;
an integrity protection algorithm, used for data integrity protection; or
an anti-replay protection algorithm.

In the embodiment of the present disclosure, the first network element receives the security capability information of the PEGC in advance, which can at least be used to determine the security algorithm supported by the PEGC. In this way, according to the security capability information of the PEGC, the first network element can select a security algorithm supported by itself and the PEGC to encrypt the operator credential.

In some embodiments, the method further includes determining a credential encryption key.

The credential encryption key may be determined by negotiation between the PEGC and the first network element, or may be determined independently by the first network element and then notified to the PEGC.

As an example, the credential encryption key may be a key used by the PEGC or the first network element for key derivation, or the credential encryption key may be a key reported by the PEGC.

In summary, there are many ways to determine the credential encryption key, and the specific implementation is not limited to any of the above.

In some embodiments, determining the credential encryption key includes:
determining the first key used by the first network element for key derivation as the credential encryption key.

In the embodiment of the present disclosure, the first key of the first network element is directly determined as the credential encryption key, and thus the first network element does not need to maintain a dedicated credential encryption key.

In some embodiments, encrypting the operator credential to obtain the encrypted credential includes:
based on the credential encryption key, the parameter update count value, a direction value, a bearer identifier, and the length value of the operator credential, encrypting the operator credential to obtain the encrypted credential.

The direction value is originally a value indicating an uplink transmission or a downlink transmission.

The bearer identifier is originally an identifier for indicating a bearer used for uplink or downlink transmission. As an example, the bearer identifier includes but is not limited to: an identifier of a data bearer and/or an identifier of a signaling bearer.

In some embodiments, the direction value and/or the bearer identifier are both preset values.

In some embodiments, the preset values of the direction value and the bearer identifier may be the same or different. For example, the direction value and the bearer identifier may both be 0X00 or FFFF, and so on.

In some embodiments, the method further includes:
sending, to the second network element, the identifier of the PEGC, the identifier of the PINE, the parameter update count value, the direction value, the bearer identifier and the algorithm identifier of the security algorithm along with the encrypted credential.

The identifier of the PEGC may inform the second network element which PEGC the encrypted credential needs to be sent to. The identifier of the PINE may inform the second network element the PINE to which the encrypted credential belongs.

After the parameter update count value, the direction value, the bearer identifier and the algorithm identifier of the security algorithm and so on are sent to the second network element, they can be sent to the PEGC by the second network element through forwarding by one or more network elements.

For example, before the second network element sends the encrypted credential to the PEGC, it can send the identifier of the PEGC and the identifier of the PINE, the parameter update count value, the direction value, the bearer identifier and the algorithm identifier of the security algorithm to the PEGC separately, or it can provide the parameter update count value, the direction value, the bearer identifier, the algorithm identifier of the security algorithm, the encrypted credential, the identifier of the PEGC and the identifier of the PINE to the PEGC.

If the parameter update count value, the direction value, the bearer identifier, and the algorithm identifier of the security algorithm are sent separately from the encrypted credential, one-time acquisition of the above data by a third party during the information transmission procedure can be reduced.

The identifier of the PEGC, the identifier of the PINE, the parameter update count value, the direction value, the bearer identifier and the algorithm identifier of the security algorithm are sent to the second network element. After receiving the identifier of the PEGC, the identifier of the PINE, the parameter update count value, the direction value, the bearer identifier and the algorithm identifier of the security algorithm, the second network element forwards them to the PEGC through one or more network elements, so that they can be used by the PEGC to decrypt the encrypted credential, perform integrity protection verification and/or credential reception confirmation.

It is worth noting that any message exchanged between the first network element and the second network element may be converted into a message for provisioning the operator credential for the PINE, and any message between the first network element and the second network element that has been proposed to perform other functions may also be reused. If existing message(s) is(are) reused, a credential configuration indicator may be added to the existing message(s). The credential configuration indicator can indicate that a currently interacted message is used for the operator credential configuration for the PINE.

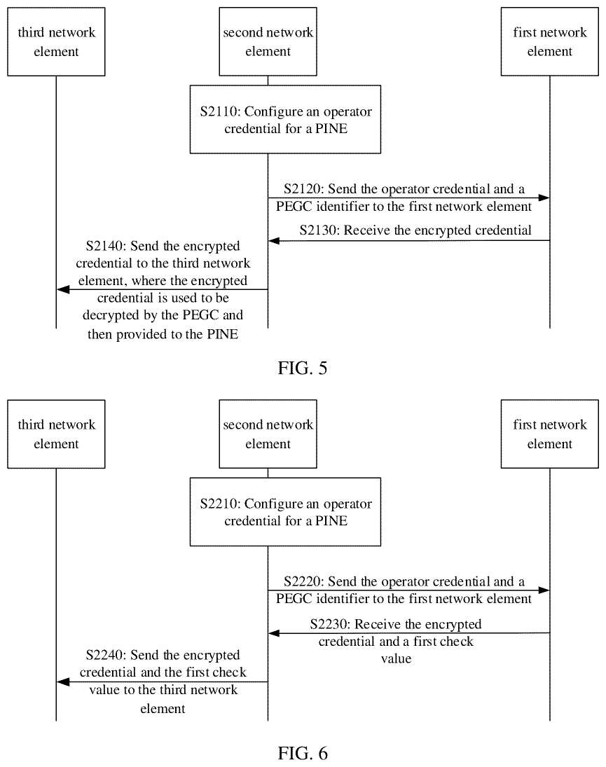

As shown in FIG. 5, an embodiment of the present disclosure provides an information processing method. The method is performed by a second network element, and the method includes:

In S2110, an operator credential is configured for a PINE.

In S2120, the operator credential and an identifier of a PEGC are sent to a first network element. The operator credential is used by the first network element to perform encryption and generate an encrypted credential based on a security algorithm supported by a PEGC indicated by the identifier of the PEGC.

In S2130, the encrypted credential is received.

In S2140, the encrypted credential is sent to a third network element, where the encrypted credential is used to be decrypted by the PEGC and then provided to the PINE.

The second network element may be a UDM.

As an example, the S2110 may include: after receiving a result of passing a default credential authentication for a PINE, configuring, by the second network element, the operator credential for the PINE. If verification of the default credential authentication for the PINE is passed, it means that the corresponding PINE is a trusted device. At this time, after the second network element configures the operator credential for the PINE, the second network element sends the identifier of the PEGC connected to the PINE and the operator credential together to the first network element, and the first network element selects a security algorithm to encrypt the operator credential to obtain the encrypted credential.

The default credential may be a credential configured when the PINE leaves the factory. The default credential may be a credential of a third party other than a communication operator. For example, the default credential may be a credential pre-configured by an AAA server.

The result that the default credential has passed the authentication may be notified to the second network element by other network element(s) such as an AUSF. As an example, the authentication of the default credential may be performed by the AAA server.

After receiving the encrypted credential, the second network element sends the encrypted credential to the third network element.

In this way, the operator credential sent by the second network element to the PEGC is an encrypted credential, which can ensure the security of the operator credential transmission.

As shown in FIG. 6, an embodiment of the present disclosure provides an information processing method. The method is performed by a second network element, and the method includes:

In S2210, an operator credential is configured for a PINE.

In S2220, the operator credential and an identifier of a PEGC are sent to a first network element. The operator credential is used by the first network element to perform encryption and generate an encrypted credential based on a security algorithm supported by a PEGC indicated by the identifier of the PEGC.

In S2230, the encrypted credential and a first check value are received.

In S2240, the encrypted credential and the first check value are sent to the third network element. The first check value is used by the PEGC to perform integrity protection verification on the encrypted credential after the first check value is sent by the third network element to the PEGC.

The encrypted credential and the first check value may be received from the first network element together, or may be received from the first network element separately.

The encrypted credential and the first check value may be sent by the second network element to the third network element together, or may be sent by the second network element to the third network element separately.

If the first network element generates the first check value, the second network element can receive the first check value sent by the first network element. The first check value can be sent to the third network element together with the encrypted credential, and then forwarded to the PEGC by the third network element. In this way, after receiving the first check value, the PEGC can perform integrity protection verification on the encrypted credential.

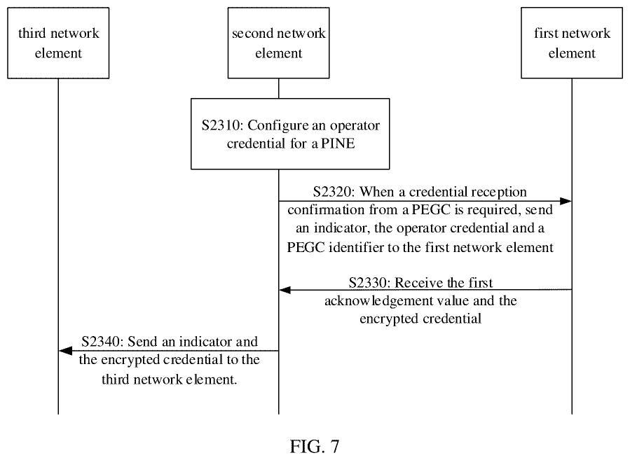

As shown in FIG. 7, an embodiment of the present disclosure provides an information processing method. The method is performed by a second network element. The method includes:

In S2310, an operator credential is configured for a PINE.

In S2320, when a credential reception confirmation from a PEGC is required, an indicator, the operator credential and an identifier of a PEGC are sent to the first network element. The indicator is used to indicate the first network element to generate a first acknowledgement value. The operator credential is used for the first network element to perform encryption and generate an encrypted credential based on a security algorithm supported by a PEGC indicated by the identifier of the PEGC.

In S2330, the first acknowledgement value and the encrypted credential are received.

In S2340, an indicator and the encrypted credential are sent to the third network element. The indicator is used to trigger the PEGC to generate a second acknowledgement value after the PEGC successfully obtains the operator credential after the indicator is sent to the PEGC by the third network element.

If the second network element expects to obtain the credential reception confirmation from the PEGC, on the one hand, the second network element needs to send an indicator to the first network element to indicate the first network element to generate the first acknowledgement value; on the other hand, the second network element needs to send an indicator to the third network element. After the indicator is forwarded to the PEGC by the third network element, the indicator triggers the PEGC to generate the second reception acknowledgement value after the PEGC confirms that the operator credential is received. In this way, the reception confirmation of the operator credential can be realized.

As shown in FIG. 8, an embodiment of the present disclosure provides an information processing method. The method is performed by a second network element, and the method includes:

In S2410, an operator credential is configured for a PINE.

In S2420, when a credential reception confirmation from a PEGC is required, the operator credential, an identifier of a PEGC and an indicator are sent to a first network element. The operator credential is used by the first network element to perform encryption and generate an encrypted credential based on a security algorithm supported by a PEGC indicated by the identifier of the PEGC. The indicator is used to indicate the first network element to generate a first acknowledgement value.

In S2430, the first acknowledgement value and the encrypted credential are received.

In S2440, an indicator and the encrypted credential are sent to a third network element. The indicator is used to trigger the PEGC to generate a second acknowledgement value after the PEGC successfully obtains the operator credential after the third network element sends the indicator to the PEGC.

In S2450, the second acknowledgement value from the PEGC is received. The second acknowledgement value is returned by the PEGC after the PEGC confirms reception of the encrypted credential.

In S2460, when the first acknowledgement value and the second acknowledgement value are the same, it is determined that the PEGC successfully receives the operator credential.

If PEGC provides the second acknowledgement value, the second network element compares the first acknowledgement value with the second acknowledgement value. If the comparison result is that they are the same, the second network element determines that the PEGC has successfully received the operator credential.

In some embodiments, the method further includes:
sending the identifier of the PINE to the first network element, where the identifier of the PINE is at least used by the first network element to generate the first acknowledgment value.

In the embodiment of the present disclosure, the second network element provides the identifier of the PINE to the first network element, so that the first network element can generate the first acknowledgement value based on the identifier of the PINE.

In some embodiments, the method further includes:
while receiving the encrypted credential from the first network element, receiving the identifier of the PEGC, the identifier of the PINE, a parameter update count value, a direction value, a bearer identifier, and an algorithm identifier of the security algorithm; and
sending, to the third network element, the identifier of the PEGC, the identifier of the PINE, the parameter update count value, the direction value, the bearer identifier and the algorithm identifier of the security algorithm along with the encrypted credential.

The second network element not only receives the encrypted credential from the first network element, but also receives the first check value and/or the second acknowledgement value, and also receives parameters related to the operator credential encryption, integrity check protection and/or credential reception confirmation. These parameters include but are not limited to at least one of the following: the identifier of the PEGC, the identifier of the PINE, the parameter update count value, the direction value, the bearer identifier, and the algorithm identifier of the security algorithm.

If the second network element receives the above-mentioned related parameters, the second network element sends them to the third network element, and the third network element forwards them to the PEGC through one or more intermediate network elements.

It is worth noting that the first network element, the second network element and the third network element can use message(s) dedicated to operator credential for the PINE to exchange any of the above information, or the first network element, the second network element and the third network element can reuse existing message(s) for implementing other function(s) to realize data interaction between the first network element, the second network element and the third network element. If existing message(s) for implementing other function(s) is (are) reused, the message(s) can carry a credential configuration indicator, which indicates that the message(s) is (are) currently used for the operator credential configuration for the PINE.

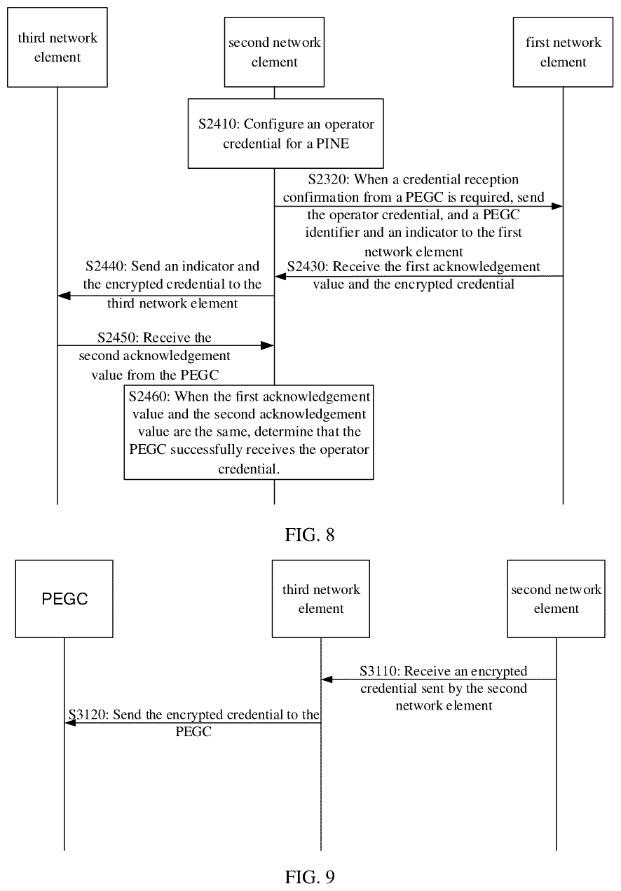

As shown in FIG. 9, an embodiment of the present disclosure provides an information processing method. The method is performed by a third network element. The method includes:

In S3110, an encrypted credential sent by a second network element is received.

In S3120, the encrypted credential is sent to a PEGC. The encrypted credential is an operator credential of a PINE encrypted according to a security algorithm supported by the PEGC.

The third network element includes but is not limited to: AMF.

After receiving the encrypted credential sent by the second network element, the third network element forwards the encrypted credential to the PEGC. For example, the third network element sends the encrypted credential to the PEGC through various NAS message(s).

In some embodiments, the method further includes:
receiving a first check value sent by the second network element; and
sending the first check value to the PEGC, where the first check value is generated according to the encrypted credential and is at least used to perform integrity protection on the encrypted credential.

In the embodiment of the present disclosure, the third network element also receives the first check value. If the first check value is received, the third network element forwards the first check value to the PEGC. For example, the third network element sends the first check value and the encrypted credential together to the PEGC.

After the first check value is forwarded to the PEGC, the PEGC is required to determine whether the encrypted credential has been tampered with during the transmission procedure based on a second check value generated locally.

As an example, the method further includes:
receiving an indicator from the second network element; and
sending the indicator to the PEGC.

If the second network element expects the PEGC to perform reception authentication of the operator credential, the third network element receives the indicator sent by the second network element, and the indicator is further forwarded to the PEGC.

If the indicator is sent to the PEGC and the PEGC successfully receives the operator credential, the third network element receives a second acknowledgement value generated by PEGC. But, if the PEGC fails to receive the operator credential, the third network element cannot receive the second acknowledgement value generated by the PEGC. Further, the third network element may receive a reception failure notification sent by the PEGC.

In some embodiments, the method further includes:
receiving the second acknowledgement value returned by the PEGC according to the indicator, where the second acknowledgement value is generated by the PEGC according to the identifier of the PINE and a first key after the PEGC determines that the operator credential is successfully received; and
sending the second acknowledgement value to the second network element.

If the third network element receives the second acknowledgement value, the third network element forwards the second acknowledgement value to the second network element, so that the second network element can compare the second acknowledgement value generated by the PEGC with the first acknowledgement value generated by the first network element. In some embodiments, the method further includes:
while receiving the encrypted credential from the second network element, receiving the identifier of the PEGC, the identifier of the PINE, the parameter update count value, the direction value, the bearer identifier, and the algorithm identifier of the security algorithm; and
when sending the encrypted credential to the PEGC, sending the identifier of the PINE, the parameter update count value, the direction value, the bearer identifier and the algorithm identifier of the security algorithm to the PEGC.

In an embodiment of the present disclosure, the third network element also receives parameter(s) for the PEGC to perform encrypted credential decryption, integrity check protection, or credential reception confirmation.

It is worth noting that the first network element, the second network element and the third network element can use message(s) dedicated to the operator credential for the PINE to exchange any of the above information, or the first network element, the second network element and the third network element can reuse existing message(s) for implementing other function(s) to realize data interaction between the first network element, the second network element and the third network element. If existing message(s) for implementing other function(s) is (are) reused, the message(s) can carry a credential configuration indicator, which indicates that the message(s) is (are) currently used for the operator credential configuration for the PINE.

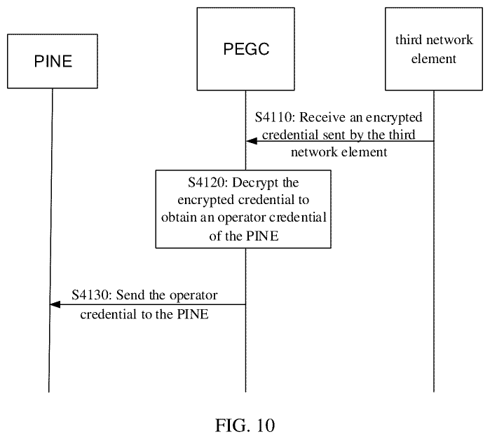

As shown in FIG. 10, an embodiment of the present disclosure provides an information processing method. The method is performed by a PEGC, and the method includes:

In S4110, an encrypted credential sent by a third network element is received.

In S4120, the encrypted credential is decrypted to obtain an operator credential of a PINE.

In S4130, the operator credential is sent to the PINE.

A secure non-3GPP connection is established between the PEGC and the PINE that applies for the operator credential.

The PEGC receives the encrypted credential sent by the third network element such as an AMF. After receiving the encrypted credential, the PEGC decrypts the encrypted credential. If the decryption is successful, the PEGC obtains the operator credential issued by a UDM for the PINE. If the operator credential is successfully decrypted, the decrypted operator credential is sent to the PINE.

If decryption by the PEGC fails, the PEGC sends information to the PINE indicating that the operator credential request failed.

In some embodiments, the method further includes:
receiving a first check value sent by the third network element;
generating a second check value according to the encrypted credential;
when the second check value is the same as the first check value, determining that the encrypted credential passes integrity protection verification, where the operator credential is obtained by performing decryption after the encrypted credential passes the integrity protection verification.

If the PEGC also receives the first check value, the PEGC locally generates the second check value according to the encrypted credential. If the second check value is the same as the first check value, it means that the encrypted credential has not been tampered with during the transmission procedure, and the PEGC determines that the encrypted credential has passed the integrity protection verification.

In the embodiment of the present disclosure, if the encrypted credential passes the integrity protection verification, the encrypted credential is decrypted; otherwise, the PEGC can directly notify the third network element of the integrity verification failure without decrypting the encrypted credential, so as to trigger the third network element to re-provide the encrypted credential.

In some embodiments, generating the second check value according to the encrypted credential includes:
receiving a parameter update count value sent by the third network element; and
when the parameter update count value sent by the third network element is greater than a parameter update count value maintained by the PEGC, generating the second check value according to the encrypted credential, the length of the encrypted credential, the parameter update count value, the length of the parameter update count value and a first key used for key derivation of a first network element.

The PEGC and the first network element such as the AUSF maintain a parameter update count value. If the parameter update count value, which is provided by the first network element and is received from the third network element, is greater than the parameter update count value maintained locally by the PEGC, the integrity protection verification is started; otherwise, the verification can be directly considered to have failed, and the decryption of the encrypted credential and the second check value is skipped directly.

In some embodiments, decrypting the encrypted credentials to obtain the operator credential of the PINE includes:
determining a security algorithm according to the algorithm identifier provided by the third network element;
according to the parameter update count value, the direction value, the bearer identifier and the first key used for key derivation of the first network element provided by the third network element, decrypting the encrypted credential to obtain the operator credential.

The algorithm identifier indicates the security algorithm used for the encrypted credential. In this way, after receiving the algorithm identifier, the PEGC can query the security algorithm by local query or query on the network using the algorithm identifier as an index value.

After determining the security algorithm, the PEGC uses the parameter update count value, the direction value, the bearer identifier and the first key provided by the third network element as the input of the security algorithm to decrypt the encrypted credential, so as to obtain the operator credential issued to the PINE by the second network element such as the UDM.

In some embodiments, the method further includes:
receiving an indicator sent by the third network element;
after receiving the indicator and successfully obtaining the operator credential, generating a second acknowledgement value according to the identifier of the PINE and the first key; and
sending the second acknowledgement value to the third network element, where the second acknowledgement value is used for the second network element to compare with the first acknowledgement value and determine whether the PEGC successfully receives the operator credential according to the comparison result after the second acknowledgement value is forwarded by the third network element to the second network element.

In the embodiment of the present disclosure, if the PEGC receives the indicator sent by the third network element, it means that the PEGC is required to confirm the reception of the credential. In this way, after the PEGC successfully obtains the operator credential through integrity verification protection and decryption of the encrypted credential, the PEGC generates the second acknowledgement value according to the identifier of the PINE and return the second acknowledgement value to the third network element, and finally the second acknowledgement value is returned to the second network element.

If the PEGC receives the indicator but fails to successfully obtain the operator credential, the PEGC does not need to generate the second acknowledgement value, and the PEGC directly sends a reception failure message to the third network element. For example, if the encrypted credential does not pass the integrity verification protection or the operator credential is found to be abnormal after decryption and does not meet an encoding rule of a legal operator credential, it can be considered that the obtaining of the operator credential has failed.

In some embodiments, generating the second acknowledgement value according to the identifier of the PINE and the first key includes:
receiving a parameter update count value sent by the third network element; and
when the parameter update count value sent by the third network element is greater than a parameter update count value maintained by the PEGC, generating the second acknowledgement value according to the identifier of the PINE, the length of the device identifier, the parameter update count value, the length of the parameter update count value and the first key used for key derivation of the first network element.

Similarly, the PEGC receives a parameter update count value. If the received parameter update count value is smaller than the parameter update count value maintained locally by PEGC, it means that there is an abnormality. In this abnormal case, the second acknowledgement value may not be generated, and it may even be considered that the received operator credential is abnormal.

It is worth noting that the interaction between the PEGC and the third network element regarding the data of the operator credential of the PINE can use message(s) dedicated to operator credential configuration for the PINE, or reuse message(s) that has(have) been proposed to implement other function(s). If the message(s) that has(have) been proposed to implement other function(s) is(are) reused, the message(s) can carry a credential configuration indicator, indicating that the message(s) is(are) currently used for the operator credential configuration for the PINE.

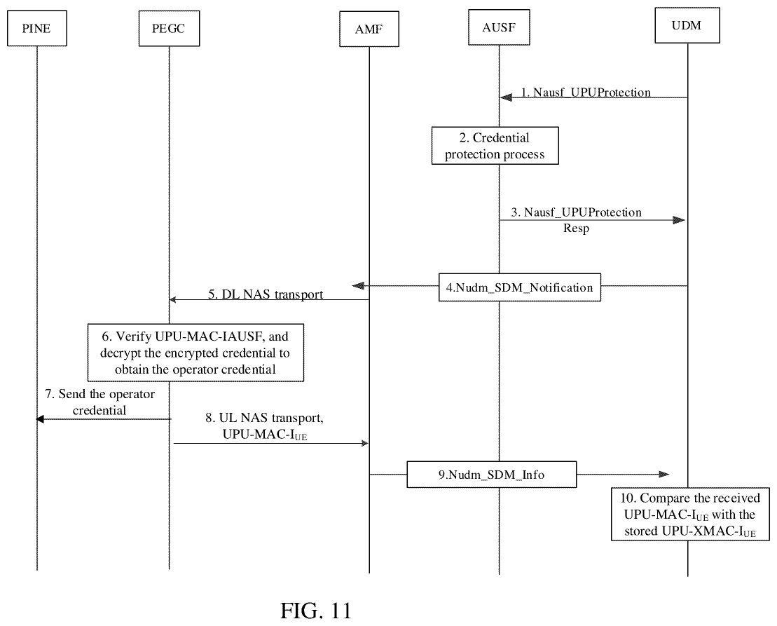

Referring to FIG. 11, in the embodiment of the present disclosure, the first key may be sent by the first network element to the PEGC during the procedure in which the PEGC is authenticated by the network device or when the PEGC registers to the network. As an example, if the first network element is AUSF, the first key may be Kausf.

It is assumed that a PINE has established a secure non-3GPP connection with a PEGC.

The PEGC has registers to the 5GC. The connection between the PEGC and an AMF is protected by NAS security. The PEGC has obtained authorization to serve as a gateway.

It is assumed that an AUSF has obtained security capability information of the PEGC, which indicates a security capability of the PEGC. In this way, the AUSF can perform security protection on the procedure of configuring an operator credential for the PINE based on the security capability information of the PEGC.

The following is the procedure of securely configuring an operator credential for the PINE, which may include the following steps:

The UDM receives a default credential authentication result confirmation request from the AUSF. The default credential authentication result confirmation request indicates that the default credential authentication of the PINE is passed. At the same time, the credential authentication result confirmation request may also include information such as the SUPI of the PEGC or the identifier of the PINE. The UDM starts the procedure of configuring an operator-owned credential to the PINE. The operator-owned credential here is the aforementioned operator credential.

The UDM starts the Nausf_UPUProtection service operation with the AUSF. The input of the service operation includes a credential configuration indicator, the SUPI of the PEGC, a device identifier of the PINE, and an operator-owned credential. The credential configuration indicator indicates that the operator credential configuration is performed for the PINE.

In addition, the UDM may add an acknowledgement (ACK) indicator to the input of the service operation. The indicator indicates that after the operator credential of the PINE is correctly received by the PEGC, an acknowledgement value needs to be returned by the PEGC.

The AUSF selects a security algorithm according to the security capability information of the PEGC to provide security protection for the operator credential configured by the UDM. The input of the security algorithm includes: a credential encryption key, a count value, a direction value, a bearer identifier, a length and an encrypted credential.

Specifically, the credential encryption key is set to K_{AUSF}. The above count value is set to a count value of a User Parameters Update (UPU) counter. The UPU count value is a type of the above parameter update count value. The direction value and the bearer identifier are both set to 0X00. The length is set to the length of the encrypted credential.

The AUSF calculates UPU-MAC-I_{AUSF}, where the AUSF generates the UPU-MAC-I_{AUSF} according to the encrypted credential itself and the length of the encrypted credential, the UPU count value, and the like.

The UPU-MAC-I_{AUSF} may be one type of the aforementioned first check value.

If the UDM adds an acknowledgement (ACK) indication in the input of the service operation, the AUSF calculates UPU-XMAC-I_{UE}. The UPU-XMAC-I_{UE} may be one type of the aforementioned first acknowledgment value. The UPU-XMAC-I_{UE} is generated by the AUSF according to the identifier of the PINE, the length of the identifier and/or the UPU count value, and the like.

The AUSF sends the SUPI of the PEGC, the identifier of the PINE, the encrypted credential, the UPU-MAC-I_{AUSF}, the count value of the UPU counter, the direction value, the bearer identifier and an algorithm identifier of the security algorithm to the UDM through the Nausf_UPUProtection service operation. If the UDM needs a credential reception confirmation from the PEGC, the AUSF sends the UPU-XMAC-I_{UE} to the UDM.

The UDM sends the credential configuration indicator, the SUPI of the PEGC, the identifier of the PINE, the encrypted credential, the UPU-MAC-I_{AUSF}, the count value of the UPU counter, the direction value, the bearer identifier and the security algorithm identifier to the AMF through the Nudm_SDM_Notification service operation.

The AMF sends the credential configuration indicator, the encrypted credential, the UPU-MAC-I_{AUSF}, the count value of the counter UPU, the direction value, the bearer identifier and the algorithm identifier of the security algorithm to the PEGC via downlink (DL) NAS transport.

The PEGC firstly generates a local UPU-MAC-I_{AUSF} based on the encrypted credential. When the UPU-MAC-I_{AUSF} is generated locally, the UE parameters Update Data is replaced by the encrypted credential. Then, the PEGC compares the locally generated UPU-MAC-I_{AUSF} with the UPU-MAC-I_{AUSF} sent by the AMF. The UPU-MAC-I_{AUSF} here is the second check value mentioned above.

If the locally generated UPU-MAC-I_{AUSF} is not equal to the UPU-MAC-I_{AUSF} sent by the AMF, the PEGC aborts the credential configuration procedure; otherwise, the PEGC accepts the credential configured by the UDM. The PEGC decrypts the encrypted credential according to K_{AUSF}, the count value of CounterUPU, the direction value, the bearer identifier and the algorithm identifier of the security algorithm.

The PEGC sends the configured credential to the PINE over the secure non-3GPP connection.

If the credential provision indicator indicates that the UDM needs a credential provisioning confirmation message from the PEGC, the PEGC generates the UPU-MAC-I_{UE} based on A.20 of 33.501. In the procedure of generating the UPU-MAC-I_{UE}, the calculation parameters p0 and L0 can be replaced by the identifier of the PINE and the length of the identifier of the PINE, respectively. The PEGC sends the newly generated UPU-MAC-I_{UE} together with the credential configuration indicator to the AMF. The process is protected by NAS security.

The AMF sends UPU-MAC-I_{UE} to the UDM through Nudm_SDM_Info service operation. The UPU-MAC-I_{UE} is the second acknowledgement value mentioned above. The Nudm_SDM_Info service operation can carry a credential configuration indicator, indicating that the Nudm_SDM_Info service operation is reused for the operator credential configuration for the PINE.

After receiving the UPU-MAC-I_{UE}, the UDM compares the UPU-MAC-I_{UE} with local UPU-XMAC-I_{UE}. If the UPU-MAC-I_{UE} is equal to local UPU-XMAC-I_{UE}, the UDM confirms that the PEGC has received the correct operator credential; otherwise, the UDM confirms that the PEGC has not received the correct operator credential, or in other words, the UDM acknowledges that incorrect credential has been provisioned to the PEGC.

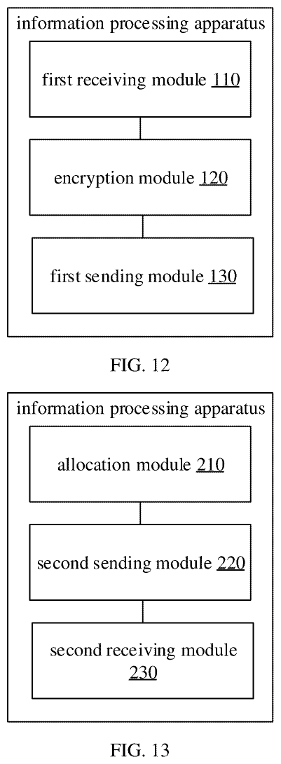

As shown in FIG. 12, an embodiment of the present disclosure provides an information processing apparatus. The apparatus includes: a first receiving module 110, an encryption module 120, and a first sending module 130.

The first receiving module 110 is configured to receive an operator credential configured by a second network element for a Personal Internet of Things Network Element (PINE).

The encryption module 120 is configured to encrypt the operator credential to obtain an encrypted credential.

The first sending module 130 is configured to send the encrypted credential to the second network element, where the encrypted credential is used for a PIN Element with Gateway Capability (PEGC) to perform decryption to obtain the operator credential.

The information processing apparatus may be included in a first network element. The first network element includes but is not limited to an AUSF.

In some embodiments, the first receiving module 110, the encryption module 120, and the first sending module 130 may be program modules; after the program modules are executed by a processor, the above operations can be implemented.

In some other embodiments, the first receiving module 110, the encryption module 120 and the first sending module 130 may be software and hardware combination modules. The software and hardware combination modules include but are not limited to: various programmable arrays; the programmable arrays include but are not limited to field programmable arrays and/or complex programmable arrays.

In some other embodiments, the first receiving module 110, the encryption module 120 and the first sending module 130 may be pure hardware modules; the pure hardware modules include but are not limited to application specific integrated circuits.

In some embodiments, the apparatus further includes:
a first generation module configured to generate a first check value for integrity protection verification according to the encrypted credential;
the first sending module 130 is further configured to send the first check value to the second network element, where the first check value and the encrypted credential are provided to the PEGC together.

In some embodiments, the generation module is further configured to generate the first check value according to the encrypted credential, the length of the encrypted credential, a parameter update count value, the length of the parameter update count value, and a first key used for key derivation of the first network element.

In some embodiments, the apparatus further includes:
a second generation module configured to generate a first acknowledgement value according to an identifier of the PINE when receiving from the second network element an indicator indicating that a credential reception confirmation from the PEGC is required;
the first sending module 130 is configured to send the first acknowledgement value to the second network element, where the first acknowledgement value is used to compare with a second acknowledgement value returned by the PEGC after the PEGC confirms reception of the operator credential.

In some embodiments, the second generation module is configured to generate the first acknowledgement value according to the identifier of the PINE, the length of the device identifier, the parameter update count value, the length of the parameter update count value, and the first key used for key derivation of the first network element.

In some embodiments, the first receiving module 110 is configured to receive security capability information of the PEGC;
the apparatus further includes:
a selection module configured to select a security algorithm for protecting the operator credential according to the security capability information.

In some embodiments, the apparatus further includes:
a first determination module configured to determine a credential encryption key.

In some embodiments, the first determination module is configured to determine the first key used by the first network element for key derivation as the credential encryption key.

In some embodiments, the encryption module 120 is configured to encrypt the operator credential to obtain the encrypted credential based on the credential encryption key, the parameter update count value, the direction value, the bearer identifier, and a length value of the operator credential.

In some embodiments, the direction value and/or the bearer identifier are both preset values.

In some embodiments, the first sending module 130 is further configured to send, to the second network element, the identifier of the PEGC, the identifier of the PINE, the parameter update count value, the direction value, the bearer identifier and the algorithm identifier of the security algorithm along with the encrypted credential.

As shown in FIG. 13, an embodiment of the present disclosure provides an information processing apparatus. The apparatus includes: an allocation module 210, a second sending module 220, and a second receiving module 230.

The allocation module 210 is configured to configure an operator credential for a PINE.

The second sending module 220 is configured to send the operator credential and an identifier of a PEGC to a first network element; wherein the operator credential is used by the first network element to perform encryption and generate an encrypted credential based on a security algorithm supported by a PEGC indicated by the identifier of the PEGC.

The second receiving module 230 is configured to receive the encrypted credential.

The second sending module 220 is configured to send the encrypted credential to a third network element, wherein the encrypted credential is used to be decrypted by the PEGC and then provided to the PINE.

The information processing apparatus may be included in a second network element. The second network element includes but is not limited to a UDM.

In some embodiments, the second sending module 220 and the second receiving module 230 may be program modules; after the program modules are executed by a processor, the above operations can be implemented.

In some other embodiments, the second sending module 220 and the second receiving module 230 may be software and hardware combination modules; the software and hardware combination modules include but are not limited to: various programmable arrays; the programmable arrays include but are not limited to field programmable arrays and/or complex programmable arrays.

In some other embodiments, the second sending module 220 and the second receiving module 230 may be pure hardware modules; the pure hardware modules include but are not limited to application specific integrated circuits.

In some embodiments, the second receiving module 230 is further configured to receive a first check value sent by the first network element, where the first check value is generated according to the encrypted credential and is at least used to perform integrity protection on the encrypted credential.

The second sending module 220 is further configured to send the first check value to the third network element, where the first check value is used for the PEGC to perform integrity protection verification on the encrypted credential after the first check value is sent by the third network element to the PEGC.

In some embodiments, the second sending module 220 is further configured to send an indicator to the first network element when a credential reception confirmation from the PEGC is required; where the indicator is used to indicate the first network element to generate a first acknowledgement value;
the second receiving module 230 is further configured to receive the first acknowledgement value;
the second sending module 220 is further configured to send an indicator to the third network element; where the indicator is used for triggering the PEGC to generate a second acknowledgement value after the PEGC successfully obtains the operator credential after the third network element sends the indicator to the PEGC;
the second receiving module 230 is further configured to receive the second acknowledgement value from the PEGC, wherein the second acknowledgement value is returned by the PEGC after confirming reception of the encrypted credential;
the apparatus further includes:
a second determination module configured to determine that the PEGC successfully receives the operator credential when the first acknowledgement value and the second acknowledgement value are the same.

In some embodiments, the second sending module 220 is further configured to send the identifier of the PINE to the first network element, wherein the identifier of the PINE is at least used by the first network element to generate the first acknowledgment value.

In some embodiments, the second receiving module 230 is further configured to receive the identifier of the PEGC, the identifier of the PINE, the parameter update count value, the direction value, the bearer identifier, and the algorithm identifier of the security algorithm while receiving the encrypted credential from the first network element;
the second sending module 220 is further configured to send, to the third network element, the identifier of the PEGC, the identifier of the PINE, the parameter update count value, the direction value, the bearer identifier and the algorithm identifier of the security algorithm along with the encrypted credential.

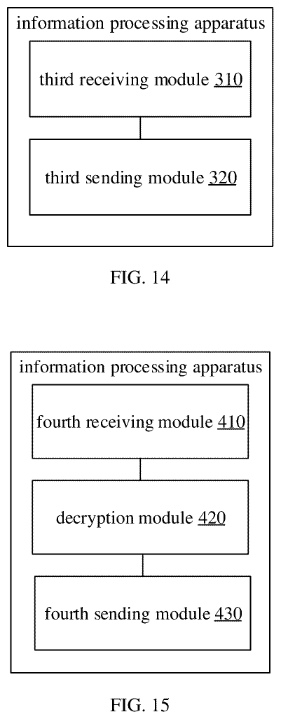

As shown in FIG. 14, an embodiment of the present disclosure provides an information processing apparatus. The apparatus includes: a third receiving module 310, and a third sending module 320.

The third receiving module 310 is further configured to receive an encrypted credential sent by a second network element.

The third sending module 320 is further configured to send the encrypted credential to a PEGC, where the encrypted credential is an operator credential of a PINE encrypted according to a security algorithm supported by the PEGC.

The information processing apparatus may be included in a third network element, which is but not limited to an AMF.

In some embodiments, the third receiving module 310 and the third sending module 320 may be program modules; after the program modules are executed by a processor, the above operations can be implemented.

In some other embodiments, the third receiving module 310 and the third sending module 320 may be software and hardware combination modules; the software and hardware combination modules may be programmable arrays; the programmable arrays may be field programmable arrays and/or complex programmable arrays.

In some other embodiments, the third receiving module 310 and the third sending module 320 may be pure hardware modules; the pure hardware modules include but are not limited to application specific integrated circuits.

In some embodiments, the third receiving module 310 is further configured to receive a first check value sent by the second network element.

The third sending module 320 is further configured to send the first check value to the PEGC, where the first check value is generated according to the encrypted credential and is at least used to perform integrity protection on the encrypted credential.

In some embodiments, the third receiving module 310 is further configured to receive an indicator from the second network element;
the third sending module 320 is further configured to send the indicator to the PEGC;
the third receiving module 310 is further configured to receive a second acknowledgement value returned by the PEGC according to the indicator, where the second acknowledgement value is generated by the PEGC according to the identifier of the PINE and a first key after the PEGC determines that the operator credential is successfully received;
the third sending module 320 is further configured to send the second acknowledgement value to the second network element.

In some embodiments, the third receiving module 310 is further configured to receive the identifier of the PEGC, the identifier of the PINE, a parameter update count value, a direction value, a bearer identifier, and an algorithm identifier of a security algorithm while receiving the encrypted credential from the second network element;
the third sending module 320 is further configured to send the identifier of the PINE, the parameter update count value, the direction value, the bearer identifier and the algorithm identifier of the security algorithm to the PEGC when sending the encrypted credential to the PEGC.

As shown in FIG. 15, an embodiment of the present disclosure provides an information processing apparatus. The apparatus includes: a fourth receiving module 410, a decryption module 420 and a fourth sending module 430.

The fourth receiving module 410 is configured to receive an encrypted credential sent by a third network element.

The decryption module 420 is configured to decrypt the encrypted credential to obtain the operator credential of a PINE.

The fourth sending module 430 is configured to send the operator credential to the PINE.

The information processing apparatus may be included in a fourth network element. The fourth network element is but not limited to a PEGC.

In some embodiments, the fourth receiving module 410, the decryption module 420 and the fourth sending module 430 may be program modules; after the program modules are executed by a processor, the above operations can be implemented.

In some other embodiments, the fourth receiving module 410, the decryption module 420 and the fourth sending module 430 may be software and hardware combination modules; the software and hardware combination modules may be programmable arrays; the programmable arrays may be field programmable arrays and/or complex programmable arrays.

In some other embodiments, the fourth receiving module 410, the decryption module 420 and the fourth sending module 430 may be pure hardware modules; the pure hardware modules include but are not limited to application specific integrated circuits.

In some embodiments, the fourth receiving module 410 is configured to receive a first check value sent by the third network element;
a third generation module is configured to generate a second check value according to the encrypted credential;
a third determination module is configured to determine that the encrypted credential passes the integrity protection verification when the second check value is the same as the first check value; the operator credential is obtained by decryption after the encrypted credential passes the integrity protection verification.

In some embodiments, the fourth receiving module 410 is further configured to receive a parameter update count value sent by the third network element;
the third generation module is configured to generate the second check value according to the encrypted credential, the length of the encrypted credential, the parameter update count value, the length of the parameter update count value and a first key used for key derivation of a first network element when the parameter update count value sent by the third network element is greater than a parameter update count value maintained by the PEGC.

In some embodiments, the decryption module 420 is further configured to: determine a security algorithm based on the algorithm identifier provided by the third network element; decrypt the encrypted credential to obtain the operator credential according to the parameter update count value, the direction value, the bearer identifier and the first key used for key derivation of the first network element provided by the third network element.

In some embodiments, the fourth receiving module 410 is configured to receive an indicator sent by the third network element;
the apparatus further includes:
a fourth generation module configured to generate a second acknowledgement value according to the identifier of the PINE and the first key after receiving the indicator and successfully obtaining the operator credential;
the fourth sending module 430 is configured to send the second acknowledgement value to the third network element, where the second acknowledgement value is used for the second network element to compare with the first acknowledgement value and determine whether the PEGC successfully receives the operator credential based on the comparison result, after the second acknowledgement value is forwarded by the third network element to the second network element.

In some embodiments, the fourth receiving module 410 is further configured to receive a parameter update count value sent by the third network element;
the fourth generation module is further configured to generate the second acknowledgement value according to the identifier of the PINE, the length of the device identifier, the parameter update count value, the length of the parameter update count value and the first key used for key derivation of the first network element when the parameter update count value sent by the third network element is greater than a parameter update count value maintained by the PEGC.

An embodiment of the present disclosure provides a communication device, including:
a memory for storing processor-executable instructions;
a processor connected with the memory;
where the processor is configured to implement the information processing method provided by any of the aforementioned technical solutions.

The processor may include various types of storage medium, which are non-transitory computer storage medium that can continue to memorize information stored thereon after the communication device is powered off.

Here, the communication device includes: a UE or a network element, and the network element can be any one of the first network element to the fourth network element mentioned above.

The processor may be connected to the memory via a bus or the like, and is configured to read an executable program stored in the memory, for example, at least one of the methods shown in FIG. 2 to FIG. 11.

Technical solutions provided by the embodiments of the present disclosure are as follows:

The operator credential can be a credential configured by an operator of a 3GPP network. If a PINE is configured with the operator credential, the first network element can receive the operator credential sent by the second network element. The first network element provides various security processing, which at least includes encrypting the operator credential to obtain the encrypted credential. Thus, the encrypted credential is transmitted to the PEGC connected to the PINE. The PEGC decrypts the encrypted credential to obtain the operator credential in a plaintext form, and the operator credential in the plaintext form is sent to the PINE. The technical solutions specify the operator credential configuration for the PINE on the one hand, and can ensure the security of the operator credential during the operator configuration procedure on the other hand.

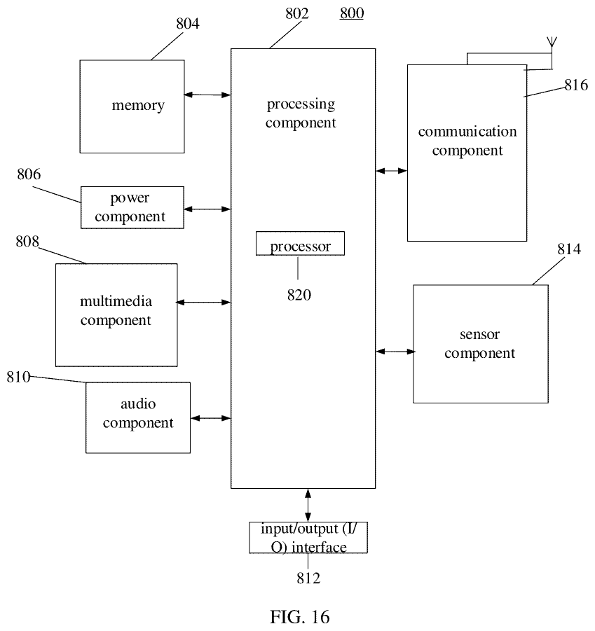

FIG. 16 is a block diagram of a UE 800 according to an example embodiment. For example, the UE 800 may be a mobile phone, a computer, digital broadcast user equipment, a messaging device, a gaming console, a tablet, a medical device, exercise equipment, a personal digital assistant, and the like.

Referring to FIG. 16, the UE 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 800 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the UE 800, for performing the above-described methods. For example, the non-transitory computer-readable storage medium may be a ROM, a Random Access Memory (RAM), a CD-ROM, a magnetic tape, a floppy disc, an optical data storage device, and the like.

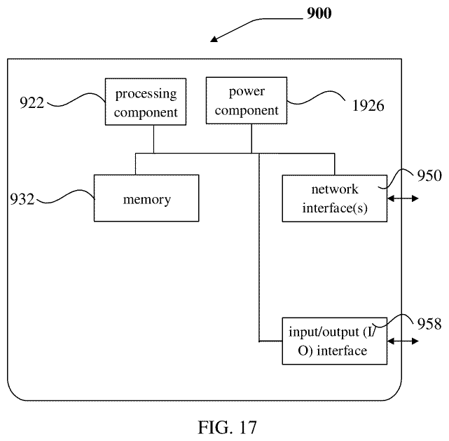

As shown in FIG. 17, an embodiment of the present disclosure shows a structure of an access device. For example, a communication device 900 may be provided as a network side device. The communication device may be various network element(s) such as the aforementioned access network element(s) and/or network function(s).

Referring to FIG. 17, the communication device 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the access device, for example, the methods shown in FIG. 2 to FIG. 11.

The communication device 900 may also include a power component 926 configured to perform power management of the communication device 900, wired or wireless network interface(s) 950 configured to connect the communication device 900 to a network, and an input/output (I/O) interface 958. The communication device 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. An information processing method, wherein the method is performed by a first network element, and the method comprises:
receiving an operator credential configured by a second network element for a Personal Internet of Things Network Element (PINE);
encrypting the operator credential to obtain an encrypted credential; and
sending the encrypted credential to the second network element, wherein the encrypted credential is used for a PIN Element with Gateway Capability (PEGC) to perform decryption to obtain the operator credential.

2. The method according to claim 1, further comprising:
generating a first check value for integrity protection verification according to the encrypted credential; and
sending the first check value to the second network element, wherein the first check value and the encrypted credential are provided to the PEGC together.

3. The method according to claim 2, wherein generating the first check value for integrity protection verification according to the encrypted credential comprises:
generating the first check value according to the encrypted credential, a length of the encrypted credential, a parameter update count value, a length of the parameter update count value and a first key used for key derivation of the first network element.

4. The method according to claim 1, further comprising:
generating a first acknowledgement value according to an identifier of the PINE when receiving from the second network element an indicator indicating that a credential reception confirmation from the PEGC is required; and
sending the first acknowledgement value to the second network element, wherein the first acknowledgement value is used to be compared with a second acknowledgement value returned by the PEGC after the PEGC confirms reception of the operator credential.

5. The method according to claim 4, wherein generating the first acknowledgement value according to the identifier of the PINE comprises:
generating the first acknowledgement value according to the identifier of the PINE, a length of the identifier of the PINE, a parameter update count value, a length of the parameter update count value, and a first key used for key derivation of the first network element.

6. The method according to claim 1, further comprising:
receiving security capability information of the PEGC; and
selecting a security algorithm for protecting the operator credential according to the security capability information.

7. The method according to claim 1, further comprising:
determining a credential encryption key.

8. The method according to claim 7, wherein determining the credential encryption key comprises:
determining the first key used for key derivation of the first network element as the credential encryption key.

9. The method according to claim 7, wherein encrypting the operator credential to obtain the encrypted credential comprises:
based on the credential encryption key, a parameter update count value, a direction value, a bearer identifier, and a length value of the operator credential, encrypting the operator credential to obtain the encrypted credential.

10. The method according to claim 9, wherein at least one of the direction value or the bearer identifier is a preset value.

11. The method according to claim 9, further comprising:
sending, to the second network element, an identifier of the PEGC, an identifier of the PINE, the parameter update count value, the direction value, the bearer identifier and an algorithm identifier of the security algorithm along with the encrypted credential.

12. An information processing method, wherein the method is performed by a second network element, and the method comprises:
after receiving a result of passing a default credential authentication for a Personal Internet of Things Network Element (PINE), configuring an operator credential for the PINE;
sending the operator credential and a identifier of a PIN Element with Gateway Capability (PEGC) to a first network element, wherein the operator credential is used by the first network element to perform encryption and generate an encrypted credential based on a security algorithm supported by a PEGC indicated by the identifier of the PEGC;
receiving the encrypted credential; and
sending the encrypted credential to a third network element, wherein the encrypted credential is used to be decrypted by the PEGC and then provided to the PINE.

13. The method according to claim 12, further comprising:
receiving a first check value sent by the first network element, wherein the first check value is generated according to the encrypted credential and is at least used to perform integrity protection on the encrypted credential; and
sending the first check value to the third network element, wherein the first check value is used by the PEGC to perform integrity protection verification of the encrypted credential after the first check value is sent to the PEGC by the third network element.

14. The method according to claim 12, further comprising:
when a credential reception confirmation from the PEGC is required, sending an indicator to the first network element, wherein the indicator is used to indicate the first network element to generate a first acknowledgement value;
receiving the first acknowledgement value;
sending an indicator to the third network element, wherein the indicator is used for triggering the PEGC to generate a second acknowledgement value after the PEGC successfully obtains the operator credential after the third network element sends the indicator to the PEGC;
receiving the second acknowledgement value from the PEGC, wherein the second acknowledgement value is returned by the PEGC after confirming reception of the encrypted credential; and
when the first acknowledgement value and the second acknowledgement value are the same, determining that the PEGC successfully receives the operator credential.

15. The method according to claim 14, further comprising:
sending an identifier of the PINE to the first network element, wherein the identifier of the PINE is at least used by the first network element to generate the first acknowledgment value.

16.-20. (canceled)

21. An information processing method, wherein the method is performed by a PIN Element with Gateway Capability (PEGC), and the method comprises:
receiving an encrypted credential sent by a third network element;
decrypting the encrypted credential to obtain an operator credential of a Personal Internet of Things Network Element (PINE); and
sending the operator credential to the PINE.

22. The method according to claim 21, further comprising:
receiving a first check value sent by the third network element;
generating a second check value according to the encrypted credential; and
when the second check value is the same as the first check value, determining that the encrypted credential passes integrity protection verification, wherein the operator credential is obtained by decrypting after the encrypted credential passes the integrity protection verification.

23. The method according to claim 21, wherein generating the second check value according to the encrypted credential comprises:
receiving a parameter update count value sent by the third network element;
when the parameter update count value sent by the third network element is greater than a parameter update count value maintained by the PEGC, generating the second check value according to the encrypted credential, a length of the encrypted credential, the parameter update count value, a length of the parameter update count value and a first key used for key derivation of a first network element.

24.-30. (canceled)

31. A communication device, comprising:
a processor;
a transceiver; and
a memory storing a program executable by the processor, wherein the processor is configured to perform the method according to claim 1.

32. A non-transitory computer storage medium storing an executable program, wherein when the executable program is executed by a processor, the processor is caused to perform the method according to claim 1.
